(19) United States
(12) Patent Application Publication
(10) Pub. No.: US 2003/0152350 A1
(43) Pub. Date: Aug. 14, 2003

(54) Optical fiber unit

(75) Inventors: Eiji Konda, Tokyo (JP); Yasuhiro Watanabe, Tokyo (JP); Nobuhisa Ishii, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: The Furukawa Electric Co., Ltd, Tokyo (JP)

(21) Appl. No.: 10/043,217

(22) Filed: Jan. 14, 2002

(51) Int. Cl. G02B 6/22

(52) U.S. Cl. 385/128; 385/141

(57) ABSTRACT

An optical fiber unit has a core optical fiber that has a first coating layer formed on a circumference thereof, and a second coating layer formed on a circumference of the first coating layer, the first coating layer being composed of a thermoplastic elastomer, and the second coating layer being composed of a thermoplastic resin.

### FIELD

The present invention relates to an optical fiber unit.

### BACKGROUND

In the case where an office (station) and subscribers (users) are connected in an optical fiber communication network, an optical fiber cable composed of plural optical fiber units is employed.

As one kind of the optical fiber cable, a fiber blowing cable is known. In the fiber blowing cable, a tube cable is previously laid, and optical fiber units are fed into the tube cable with compressed air and the like, in accordance with the subsequent subscription increase of the subscribers.

As the optical fiber unit used in the fiber blowing cable, an optical fiber is employed. The optical fiber referred to herein is formed with one or plural optical fibers, or a fiber ribbon which is commonly assembled in a co-planar array having two, four, six, eight, twelve, sixteen or twenty-four fibers (each of which are defined as the core fibers in the present invention), in which the core fibers are coated with, for example, polyethylene, polypropylene or polyamide (nylon) as a jacket.

In recent years, as an optical fiber unit, a multi-fiber unit, which consists of stacked plural fiber ribbons therein, is used according to the growth of the optical fiber communication network. When the multi-fiber unit is fed into the tube cable with compressed air and the like, it is difficult to install the unit into the cable for a long-length, due to the large weight of the optical fiber unit itself composed of the multiple-optical fibers.

Consequently, in order to solve the problem, it has been investigated that the diameter of the multi-optical fiber unit is reduced to save the weight thereof, whereby the long-length installation property into the tube cable is improved.

On the other hand, with respect to reduction of the weight of the fiber ribbon, which is assembled in a coplanar array having plural optical fibers and coated all in one, the conventional fiber ribbon having a thickness of 400 μm is thinned to 300 μm. Since the thickness of the fiber ribbon is reduced, the number of stacked fiber ribbons can be increased at the same unit diameter, and therefore the number of optical fibers in the unit can be increased at the same diameter. However, when the thickness of the ribbon matrix is simply reduced, the lateral pressure on the core optical fibers increases and affects the core optical fibers, to cause such a problem that the transmission loss is increased.

The ribbon matrix has been removed by using a tool, such as a blade, but this process takes risks of cracking on fiber by using the tool. There is also a matter of taking a working cost to take out an optical fiber from a fiber ribbon.

### SUMMARY

The present invention is an optical fiber unit that comprises a core optical fiber comprising a first coating layer formed on a circumference thereof, and a second coating layer formed on a circumference of the first coating layer, wherein the first coating layer comprises a thermoplastic elastomer, and wherein the second coating layer comprises a thermoplastic resin.

Other and further features and advantages of the invention will appear more fully from the following description, take in connection with the accompanying drawings.

### BRIEF DESCRIPTION OF THE DRAWINGS

FIG. 1 is a cross sectional view showing one embodiment of the optical fiber unit of the present invention.

FIG. 2 is a cross sectional view showing another embodiment of the optical fiber unit of the present invention.

FIG. 3 is an explanatory view showing the method for bending an optical fiber unit in compliance with the bending test in the example.

### DETAILED DESCRIPTION

According to the present invention, there is provided the following means.

(1) An optical fiber unit, comprising a core optical fiber comprising a first coating layer formed on a circumference thereof, and a second coating layer formed on a circumference of the first coating layer, wherein the first coating layer comprises a thermoplastic elastomer, and wherein the second coating layer comprises a thermoplastic resin.

(2) The optical fiber unit as described in the item (1), wherein the thermoplastic elastomer of the first coating layer has a modulus of elasticity in tension of from 3 to 25 MPa.

(3) The optical fiber unit as described in the item (1) or (2), wherein the thermoplastic elastomer of the first coating layer is a hydrogenated styrene-isoprene block copolymer.

(4) The optical fiber unit as described in the item (1), (2) or (3), wherein the second coating layer contains polypropylene in an amount of from 2 to 40 parts by weight, per 100 parts by weight of the thermoplastic resin.

(5) The optical fiber unit as described in the item (1), (2), (3) or (4), wherein the first coating layer contains polypropylene in an amount of from 2 to 30 parts by weight, per 100 parts by weight of the thermoplastic elastomer.

(6) The optical fiber unit as described in the item (4) or (5), wherein the polypropylene is in a form of powder having an average particle diameter of 2,000 μm or less.

The thermoplastic elastomer to be used in the present invention is a polymer material that behaves as a rubber elastic body at ordinary temperatures but suffers plastic deformation with rise in temperature. The hydrogenated styrene-isoprene block copolymer for use in the present invention is a block copolymer obtained by hydrogenating a styrene-isoprene block copolymer. The modulus of elasticity in tension as defined in the present invention is measured, complied with JIS K7113.

The preferred embodiments of the optical fiber unit of the present invention will be described according to the drawings.

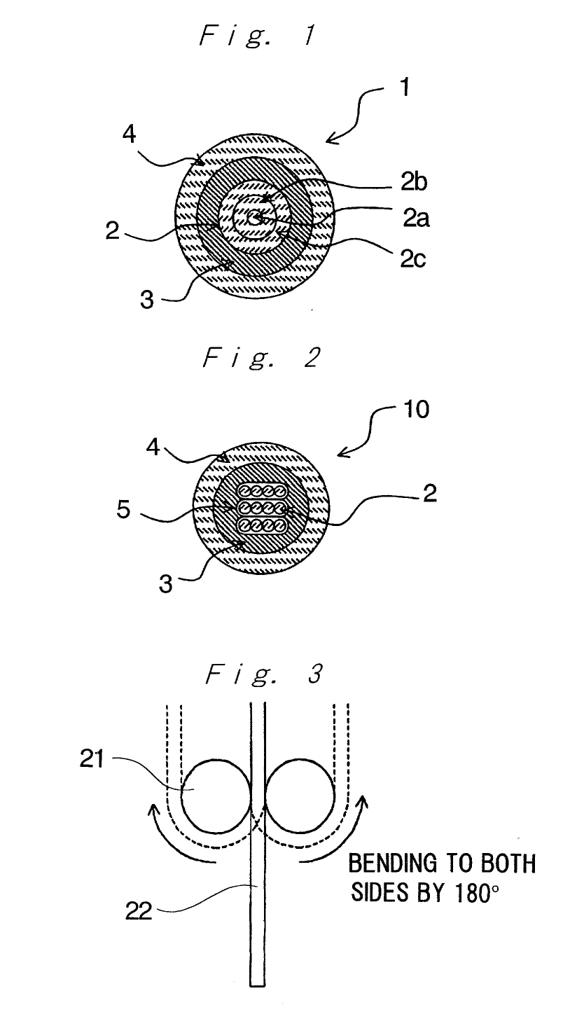

FIG. 1 is a cross sectional view of one embodiment of the optical fiber unit of the present invention which shows an optical fiber unit 1, a core optical fiber 2, a first coating layer 3, and a second coating layer 4. The core optical fiber 2 is an optical fiber consists of a core 2a , a cladding 2b and a protective layer (primary coating and secondary coating) 2c , and various types of optical fiber, such as a single-mode optical fiber and a multimode optical fiber, can be used therefor depending on purpose.

The outer diameter of the core optical fiber for use in the present invention is not particularly limited, and any type of them that are used in ordinary optical fiber units can be employed. The optical fiber unit of the present invention can be preferably prevented from affecting the lateral pressure even when an optical fiber having a thin protective layer is employed.

The first coating layer 3 is formed with a thermoplastic elastomer on the circumference of the optical fiber 2. Since the first coating layer 3 has elasticity like vulcanized rubber, it can function as an excellent buffering layer for the core optical fiber 2. The thermoplastic elastomer for use in the present invention preferably has a modulus of elasticity in tension of from 3 to 25 MPa. The modulus of elasticity in tension is more preferably from 5 to 20 MPa, and particularly preferably from 8 to 12 MPa. When the modulus of elasticity in tension is too large, the first coating layer declined with properties as a buffering layer. Since the optical fiber unit is loaded lateral pressure which results from contact between the unit and the inside of a pipe that is curved at a small diameter, during fiber-installing, thereby the optical fiber unit may cause the increase of transmission loss. On the other hand, when the modulus of elasticity in tension is too small, the optical fiber unit may easily increase transmission loss by lateral pressure, because the low elasticity reduces the property as a buffering layer, and the flexibility of the unit becomes poor, whereby the feeding (e.g. blowing) property with compressed air or the like is deteriorated. There are also some cases where extrusion fluctuation causes surface failure on extension processing.

The thermoplastic elastomer that can be used in the first coating layer in the present invention is not particularly limited as far as it satisfies the foregoing conditions, and examples thereof include a styrene series, an olefin series, a vinyl chloride series, a urethane series, an ester series, an amide series, an ethylene series, a fluorine series, a homopolymer series, an ionomer series and a polymer alloy series, with a styrene-series thermoplastic elastomer being preferred. It is preferred in the present invention that polypropylene is added to the thermoplastic elastomer of the first coating layer in an amount of from 2 to 30 parts by weight per 100 parts by weight of the thermoplastic elastomer, and the polypropylene is preferably added in a form of powder (which preferably has an average particle diameter of 2,000 μm or less). When the content of the polypropylene is too small, the coating layer is not able to tear continuously because of shreding the coating layer, and thus the optical fiber is difficult to be taken out. When the content of the polypropylene is too large, since the modulus of elasticity is increased, the coating layer deteriorates the function as the buffer layer of the optical fiber because of increment in modulus of elasticity.

In the present invention, a hydrogenated styrene-isoprene block copolymer, for example, a styrene-ethylene-propylene-styrene copolymer (SEPS), is particularly preferably used in the first coating layer. The hydrogenated styrene-isoprene block copolymer has various advantages. That is, it has thermoplasticity suitable for extrusion processing, and rubber elasticity and mechanical strength suitable for a buffer material, and also has heat degradation resistance and weather resistance. Further, it has a wide extruding temperature range and a small shrinkage at low temperatures owing to low crystallinity thereof. Accordingly, the copolymer having a styrene-unit content from 5 to 30% by weight is preferred, and the copolymer having a glass transition temperature from −100 to 0° C. is preferred. Specific examples of the preferred thermoplastic elastomer having such preferred characteristics include SEPTON 2063 (trade name, produced by Kuraray Co., Ltd.).

In the present invention, though the first coating layer thickness is not particularly limited, and from the standpoint of improvement in feeding property and buffering effect against the lateral pressure, it is preferable, when it is considered that improvement of feeding property and effectivity of buffer layer against lateral pressure, from 5 to 500 μm, and more preferable from 100 to 200 μm.

The second coating layer 4 is formed on a circumference of the first coating layer 3, using a thermoplastic resin. In the present invention, since the first coating layer is formed by the thermoplastic elastomer with low elasticity, feeding property thereof is deteriorated. Because of an optical fiber unit which is provided only the first coating layer, the friction against the inner wall of the pipe increases, during installing into the tube cable. Therefore, the second coating layer comprising a thermoplastic resin is provided on the first coating layer 1 to lower the friction resistance with the inner wall of the pipe, whereby the feeding property to the tube cable is improved.

The thermoplastic resin to be used for forming the second coating layer in the present invention is not particularly limited, but it is not the same thermoplastic elastomer that is used in the first coating layer. Examples of the thermoplastic resin that can be used in the present invention include a polyolefin series, an acrylic series, an epoxy series, a polyurethane series, an ethylene-vinyl acetate series, a polyamide series, a vinyl chloride series and an a-olefin series. It is preferably a polyolefin-series resin, such as a low-density, medium-density or high-density polyethylene, linear low-density polyethylene, and polypropylene. Among these, it is particularly preferred that polypropylene is contained in the thermoplastic resin in an amount of from 2 to 40 parts by weight per 100 parts by weight of the thermoplastic resin. The polypropylene is preferably added in a form of powder (which preferably has an average particle diameter of 2,000 μm or less). The use of the polypropylene can further improve the tearing property in the longitudinal direction (i.e., stripping property) of the first coating layer after extrusion processing, and therefore, upon taking out the optical fiber from the coating, the coating layers can be split in the longitudinal direction without the use of tool.

When the content of the polypropylene in the thermoplastic resin is too small, the coating layer is not able to tear continuously because of shreding the coating layer, and thus the optical fiber is difficult to be taken out. On the other hand, when the content of the polypropylene is too large, the rigidity of the optical fiber unit itself is increased to deteriorate the handling property, and further the polypropylene fails to present in a form of short fibers in the thermoplastic resin thus extruded, whereby the tearing property of the coating is deteriorated.

The second coating layer thickness in the present invention is not particularly limited, and is preferably from 100 to 500 μm, and more preferably from 150 to 350 μm. When the second coating layer is too thick, the first coating layer is necessarily thin to fail to function as a buffering material. Since the optical fiber unit is loaded lateral pressure which results from contact between the unit and the inside of a pipe that is curved at a small diameter, during fiber-installing, thereby the optical fiber unit may cause the increase of transmission loss. On the other hand, when the second coating layer is too thin, the first coating layer is necessarily thick to increase the weight of the optical fiber unit, and there are some cases where the optical fiber unit is difficult to be fed in the pipe in good conditions.

In the present invention, the second coating layer may be provided with foaming. In the case where the second coating layer is formed by foaming, either the physical foaming method, in which an inert gas, such as nitrogen and carbon dioxide, is injected in the course of a cylinder of an extruder to cause extrusion foaming, or the chemical foaming method, in which a compound having the thermoplastic resin containing a chemical foaming agent (such as azodicarbonamide (ADCA) and oxybisbenzenesulfonyl hydrazide (OBSH)) is extruded to cause foaming, may be used. An optical fiber unit having the foamed second coating layer has a small weight and high flexibility, in comparison to an optical fiber unit having only solid layers. Therefore, in the case where the optical fiber unit is installed in a pipe by feeding and inserting under pressure with compressed air or a high-pressure nitrogen gas, it can be fed in good condition irrespective to the shape of the pipe laid at various curvatures, and thus can be preferably used as an optical fiber cable for gas pressure feeding.

In the present invention, polypropylene may be used as powder added by dry blending to the thermoplastic resin of the second coating layer or the thermoplastic elastomer resin of the first coating layer, upon extrusion. It may be also directly kneaded with the thermoplastic resin or the thermoplastic elastomer to form masterbatchs.

As described in the foregoing, because the optical fiber unit of the present invention uses the thermoplastic elastomer of low elasticity in the first coating layer and the thermoplastic resin in the second coating layer, the buffering property to the core optical fiber is excellent, the affection of the lateral pressure is suppressed, the increase of transmission loss is suppressed, and the feeding property is excellent. In the case where the second coating layer is a foamed layer, such advantages can further be obtained that the weight of the optical fiber unit can be reduced to further improve the feeding property to the tube cable.

FIG. 2 is a cross sectional view showing another embodiment of the optical fiber unit of the present invention, in which multiple core fibers are used.

In the optical fiber unit 10 shown in FIG. 2, numeral 5 denotes a fiber ribbon that is commonly assembled in a co-planar array having plural core optical fibers 2, as mentioned in the above. A first coating layer 3 is coated on a circumference of a center part formed of plurality of the fiber ribbons, and a second coating layer 4 is formed on a circumference of the first coating layer 3.

As embodiments of the multiple core fibers, one or plurality of the fiber ribbons are used, or in alternative, plural core optical fibers having a single core are used. Because the lateral pressure can be preferably prevented from affecting the core optical fibers in the present invention even when core optical fibers having a thin coating layer as described in the foregoing, a fiber ribbon having thin coatings for increasing the number of core fibers and reducing the diameter can be preferably employed.

In the case where the multiple core fibers are used, the core optical fiber, and the resins for use in the first coating layer and the second coating layer, and the details of the functions thereof are the same as those described hereinabove for the embodiment referring to FIG. 1.

In the optical fiber unit of the present invention, another coating layer having various characteristics may be formed on the second coating layer as far as the another layer does not impair the characteristics that are intended in the present invention.

In the optical fiber unit of the present invention, because the thermoplastic elastomer, preferably having a specific modulus of elasticity in tension, is used in the first coating layer, and the thermoplastic resin is used in the second coating layer, an optical fiber unit having such advantages can be obtained that the buffering property to the core optical fibers is excellent, the influence of the lateral pressure is suppressed, the transmission loss caused by increase of the number of core fibers and reduction of the diameter is suppressed, and the feeding property into the tube cable is good. In the case where the second coating layer is a foamed layer, such advantages can further be obtained that the weight of the optical fiber unit can be further reduced, to further improve the long-length installation property into the tube cable. According to the optical fiber unit of the present invention, the affection of the lateral pressure can be suppressed even when each of the thickness of the first coating layer and the second coating layer is not larger than the coating layer of the conventional optical fiber unit or even when a fiber ribbon of a whole coating layers having an extremely small thickness is used. Therefore, an optical fiber unit composed of a large number of core fibers and a small diameter, which is preferable as a fiber-installing-type optical fiber cable, can be provided.

In the present invention, a polypropylene resin is preferably added to the thermoplastic resin of the second coating layer, in an amount of from 2 to 40 parts by weight, per 100 parts by weight of the thermoplastic resin, upon extrusion, in view of improvement of workability. As a result, individual domains of the polypropylene are present in a form of short fibers in the thermoplastic resin, so as to improve the tearing property in the longitudinal direction (i.e., stripping property) of the second coating layer after extrusion processing. Resultantly, upon taking out the optical fiber from the coating, the coating layer can be split in the longitudinal direction without the use of tool. In the case where the polypropylene is added to the thermoplastic elastomer of the first coating layer, the same effects as in the second coating layer can also be obtained, and the tearing property of the coating can be further improved.

Furthermore, the workability of tip ends or the like of the optical fiber unit can be improved by the improvement of the tearing property of the coating, and thus an optical fiber unit preferable for distributing among equipments and for distributing in an equipment can be provided.

The present invention will be described in more detail with reference to the following examples, but the invention is not construed as being limited thereto.

### EXAMPLE

### Examples 1 to 4 and Reference Examples 1 to 3

An optical fiber unit 10, as shown in FIG. 2, was produced in the following procedures.

A single-core optical fiber 2 (core fiber diameter: 250 μm) was used, which had a quartz-series single-mode optical fiber having an outer diameter of 125 μm composed of a core and a cladding having formed thereon two coating layers with a urethane acrylate-series ultraviolet ray curable resin. Four strands of the core optical fibers 2 were assembled in a co-planar array to form a fiber ribbon 5 having a small thickness of 300 μm. Three layers of the fiber ribbon 5 were laminated and arrayed, and then a first coating layer 3 (thickness: 150 μm) of a styrene-series thermoplastic elastomer having the modulus of elasticity in tension shown in Table 2 below, and a second coating layer 4 (thickness: 200 μm) of a thermoplastic resin (high-density polyethylene) were simultaneously extruded around thereto, to produce the optical fiber unit 10.

The thermoplastic elastomers used in the first coating layers 3 of Examples 1 to 4 were prepared by using SEPTON 2063 (trade name, produced by Kuraray Co., Ltd.). The first coating layers 3 of Reference Examples 1 to 3 were prepared by using an ethylene-vinyl acetate copolymer (EVA).

SEPTON 2063 used in the first coating layer had the characteristics, as shown in Table 1 below.

TABLE 1
SEPTON 2063

| | Styrene-series thermoplastic elastomer resin |
|---|---|
| | (styrene-unit content: 13% by weight) |
| | Hydrogenated styrene-isoprene block copolymer |
| Structure | (styrene-ethylene-propylene-styrene) |
| Specific gravity | 0.89 |
| MFR (g per 10 min) | 230° C. · 2.16 kg: 7 |
| Tensile strength (MPa) | 10.1 |
| Elongation at fracture (%) | 1,184 |
| 100% M₀ (MPa) | 0.39 |
| Modulus of elasticity in tension | 8 to 12 |
| (MPa) | |
| Brittleness (F0: crack) (° C.) | −69 |
| Glass transition temperature (Tg) (° C.) | −53 |

The optical fiber units produced in the foregoing procedures were tested and evaluated for the lateral pressure characteristics and the bending characteristics in the following manner. The results are shown in Table 2 below.

(1) Lateral Pressure Test

An optical fiber unit containing core optical fibers inside was inserted between two flat plates having a dimension of 20 mm×20 mm. A load of 98 N was applied on the flat plates, and the transmission loss of the optical fiber unit was measured by the cut back method. The measurement was carried out with two wavelengths, 1.31 μm and 1.55 μm. The transmission loss is necessarily less than 0.1 dB/km at a measurement wavelength of 1.55 μm upon practical use. The results shown in Table 2 are indicated in terms of the following criteria. ◯: The transmission loss was less than 0.1 dB/km for the measurement wavelengths of 1.55 μm and 1.31 μm.

X: The transmission loss was 0.1 dB/km or more for one of the measurement wavelengths of 1.55 μm and 1.31 μm.

(2) Bending Test

As shown in FIG. 3, an optical fiber unit 22 containing core optical fibers inside was inserted between two cylinders 21 having a diameter of 50 mm. The optical fiber unit 22 was bent to both sides along the cylinders 21 each by 1800, which was defined as one (1) operation, and this operation was repeated ten (10) times. The transmission loss of the optical fiber unit after bending was measured by the cut back method. The measurement was carried out with two wavelengths, 1.31 μm and 1.55 μm. The transmission loss is necessarily less than 0.1 dB/km at a measurement wavelength of 1.55 μm upon practical use. The results shown in Table 2 are indicated according to the same criteria as in the evaluation of the lateral pressure test (1).

TABLE 2

| | Reference | | | | | Reference | Reference |
|---|---|---|---|---|---|---|---|
| | Example 1 | Example 1 | Example 2 | Example 3 | Example 4 | Example 2 | Example 3 |
| Second coating layer | High-density polyethylene | | | | | | |
| Modulus of elasticity in tension of first | 2 | 5 | 10 | 18 | 25 | 30 | 50 |
| coating layer (MPa) | | | | | | | |
| Lateral pressure characteristics | X | ◯ | ◯ | ◯ | ◯ | X | X |
| Bending characteristics | X | ◯ | ◯ | ◯ | ◯ | X | X |

It is apparently understood from the results shown in Table 2 that the optical fiber units of Examples 1 to 4 exhibited satisfactory low transmission loss in both the lateral pressure test and the bending test, and therefore, the first coating layer preferably showed the buffering effect, to provide excellent optical fiber units. Contrary to the above, the optical fiber unit of Reference Example 1 that was too low in modulus of elasticity in tension of the first coating layer and the optical fiber units of Reference Examples 2 and 3 that were too high in modulus of elasticity in tension of the first coating layer each exhibited practically defective values of the transmission loss in the two tests.

The optical fiber units of Examples 1 to 4 had a large number of core fibers and a small diameter with suppressing transmission loss as described in the foregoing, and therefore, it is understood that they were excellent in installation (feeding) property into a tube cable.

### Examples 5 to 12 and Reference Examples 4 to 7

A first coating layer having a coating thickness of 150 μm and a second coating layer having a coating thickness of 200 μm were provided by extrusion-molding on an outer circumference of a core optical fiber of 250 μm, so as to obtain an optical fiber unit having a final outer diameter of 950 μm.

By using the structure and the dimension of the foregoing optical fiber unit in common, optical fiber units of the examples and the reference examples were obtained by varying the mixing ratio of polypropylene powder, as shown in Table 3 below. The contents of the polypropylene powder shown in Table 3 are indicated in terms of part by weight, per 100 parts by weight of the thermoplastic elastomer of the first coating layer or 100 parts by weight of the thermoplastic resin of the second coating layer.

The thermoplastic elastomer used in the first coating layer was the styrene-series thermoplastic elastomer resin shown in Table 1 (trade name: SEPTON 2063). The thermoplastic resin of the second coating layer was obtained by using high-density polyethylene having a density of 0.953 g/cm³ and a melt flow rate of 0.8 g per 10 min.

The optical fiber units produced in the foregoing procedures were subjected to the tearing test and the lateral pressure characteristics test in the following manner. The results are shown in Table 3 below.

TABLE 3

| | | | | | | | | | Reference | | | |
|---|---|---|---|---|---|---|---|---|---|---|---|---|
| | Example | | | | | | | | Example | | | |
| | 5 | 6 | 7 | 8 | 9 | 10 | 11 | 12 | 4 | 5 | 6 | 7 |
| Polypropylene powder content | 0 | 0 | 0 | 0 | 25 | 4 | 25 | 4 | 0 | 0 | 0 | 40 |
| in first coating layer | | | | | | | | | | | | |
| Polypropylene powder content | 4 | 10 | 25 | 35 | 4 | 4 | 35 | 35 | 0 | 1 | 60 | 4 |
| in second coating layer | | | | | | | | | | | | |
| Tearing test | ◯ | ◯ | ◯ | ◯ | ◯ | ◯ | ◯ | ◯ | X | X | X | ◯ |
| Lateral pressure | ◯ | ◯ | ◯ | ◯ | ◯ | ◯ | ◯ | ◯ | ◯ | ◯ | ◯ | X |
| characteristics | | | | | | | | | | | | |

(Tearing test)

An incision of a length of about 10 mm was made on one cross section of an optical fiber unit in the longitudinal direction of the optical fiber unit to divide it into two at a position immediately next to the outer side-circumference of the core optical fiber positioned at the center.

The two pieces on both sides of the incision was pulled by hands to tear the coating layer. One that could be continuously torn by 500 mm or more was designated to as passing the test (indicated by ◯), and one that was broken in the coating layer less than 500 mm was designated to as not passing the test (indicated by X).

(Lateral-pressure test)

The same procedures and evaluations as in Examples 1 to 4 were carried out.

Having described our invention as related to the present embodiments, it is our intention that the invention not be limited by any of the details of the description, unless otherwise specified, but rather be construed broadly within its spirit and scope as set out in the accompanying claims.

What is claimed is:

1. An optical fiber unit, comprising a core optical fiber comprising a first coating layer formed on a circumference thereof, and a second coating layer formed on a circumference of said first coating layer, wherein said first coating layer comprises a thermoplastic elastomer, and wherein said second coating layer comprises a thermoplastic resin.

2. The optical fiber unit as described in claim 1, wherein said thermoplastic elastomer of said first coating layer has a modulus of elasticity in tension of from 3 to 25 MPa.

3. The optical fiber unit as described in claim 1, wherein said thermoplastic elastomer of said first coating layer is a styrene-series, an olefin-series, a vinyl chloride-series, a urethane-series, an ester-series, an amide-series, an ethylene-series, a fluorine-series, a homopolymer-series, an ionomer-series, or a polymer alloy-series thermoplastic elastomer.

4. The optical fiber unit as described in claim 1, wherein said thermoplastic elastomer of said first coating layer is a hydrogenated styrene-isoprene block copolymer.

5. The optical fiber unit as described in claim 4, wherein said hydrogenated styrene-isoprene block copolymer has a styrene-unit content of from 5 to 30% by weight and a glass transition temperature of from −100 to 0° C.

6. The optical fiber unit as described in claim 1, wherein said thermoplastic resin of said second coating layer is a polyolefin-series, an acrylic-series, an epoxy-series, a polyurethane-series, an ethylene-vinyl acetate-series, a polyamide-series, a vinyl chloride-series, or an -olefin-series resin, provided that the thermoplastic resin is not the same thermoplastic elastomer that is used in the first coating layer.

7. The optical fiber unit as described in claim 6, wherein said thermoplastic resin of said second coating layer is a low-density, medium-density or high-density polyethylene resin, a linear low-density polyethylene resin, or a polypropylene resin.

8. The optical fiber unit as described in claim 1, wherein said second coating layer contains polypropylene in an amount of from 2 to 40 parts by weight, per 100 parts by weight of said thermoplastic resin.

9. The optical fiber unit as described in claim 8, wherein said polypropylene is in a form of powder having an average particle diameter of 2,000 μm or less.

10. The optical fiber unit as described in claim 1, wherein said first coating layer contains polypropylene in an amount of from 2 to 30 parts by weight, per 100 parts by weight of said thermoplastic elastomer.

11. The optical fiber unit as described in claim 10, wherein said polypropylene is in a form of powder having an average particle diameter of 2,000 μm or less.

12. The optical fiber unit as described in claim 1, wherein said second coating layer is a foamed layer.

13. The optical fiber unit as described in claim 1, wherein said thermoplastic elastomer of said first coating layer is a hydrogenated styrene-isoprene block copolymer having a modulus of elasticity in tension of from 3 to 25 MPa, said thermoplastic resin of said second coating layer is a low-density, medium-density or high-density polyethylene resin, said second coating layer contains polypropylene in an amount of from 2 to 40 parts by weight, per 100 parts by weight of said thermoplastic resin, and said first coating layer contains polypropylene in an amount of from 2 to 30 parts by weight, per 100 parts by weight of said thermoplastic elastomer.
